(19) United States
(12) Patent Application Publication
(10) Pub. No.: US 2026/0049881 A1
(43) Pub. Date: Feb. 19, 2026

(54) Universal Mounting System for a Wheel Balancer

(71) Applicant: Allan Hjorth Hansen, Panama City (PA)

(72) Inventor: Allan Hjorth Hansen, Panama City (PA)

(21) Appl. No.: 19/370,546

(22) Filed: Oct. 27, 2025

Related U.S. Application Data
(63) Continuation-in-part of application No. 18/932,333, filed on Oct. 30, 2024.
(60) Provisional application No. 63/546,500, filed on Oct. 30, 2023.
(60) Provisional application No. 63/712,313, filed on Oct. 25, 2024.

(51) Int. Cl. G01M 1/04

(52) U.S. Cl. CPC G01M 1/045

(57) ABSTRACT

A universal mounting system for a wheel balancer is a system that facilitates the mounting of a wheel to a wheel balancer in such a way that gravity effects are eliminated by utilizing the captured spring in the balancer hub. The system includes a spacer disk that centers on the balancer hub for greater balancing accuracy. The spacer disk accommodates a low-tapered cone/collet with direct access to the captured spring for proper balancing of the mounted wheel. The spacer disk includes a first open base, a second open base, an annular ledge, a lateral disk wall, and a shaft-receiving hole. The first open base accommodates the cone/collet and the stud nipples used with a centering plate. The second open base accommodates the balancer hub. The annular ledge allows the spacer disk to engage the balancer hub. The shaft-receiving hole accommodates the balancer shaft and the cone/collet.

The current application claims a priority to the U.S. provisional patent application Ser. No. 63/712,313 filed on Oct. 25, 2024. The current application is filed on Oct. 27, 2025, while Oct. 25, 2025, was on a weekend.

The current application is also a continuation-in-part (CIP) application of a U.S. non-provisional application Ser. No. 18/932,333 filed on Oct. 30, 2024. The U.S. non-provisional application Ser. No. 18/932,333 claims a priority to a U.S. provisional patent application Ser. No. 63/546,500 filed on Oct. 30, 2023.

### FIELD OF THE INVENTION

The present invention relates generally to wheel balancers and wheel accessories. More specifically, the present invention discloses a system that enables a selected wheel to be efficiently mounted onto a wheel balancer in such a way that the effects of gravity are reduced to improve the balance accuracy of the desired wheel.

### BACKGROUND OF THE INVENTION

In general, vehicle wheels are best balanced using a conical device (e.g., a cone or collet) that centers the wheel on a wheel balancer shaft. A clamping tool is also used to secure the wheel to the wheel balancer hub which often includes a spring-loaded mechanism. The spring-loaded mechanism allows automatic compensation for any inaccuracy in the stud device as well as thickness variations in the wheel itself. The clamping tool serves as the “dynamic torquing” device that forces the wheel to sit straight on the wheel balancer and the cone/collet serves as the “static centering” device that centers the wheel exactly on the wheel balancer shaft while trying to overcome the effects of gravity. This combination works great on standard car wheels and pickup truck wheels due to the low weight, up to and around 80 pounds (lbs.). For heavy commercial wheels, a wheel balancer system utilizes a centering disk with the same diameter as the truck hub and a centering plate with studs, wherein the studs have an extended nipple that leans on the spacer disk. The centering plate has a large manufacturing specification in the center bore of the wheel. The disk also has a large tolerance, though not near as large as the plate. As a result, the centering disk only pre-centers the wheel, and the studs with the nipples end up doing the final centering which achieves an adequate result.

Due to the play between the wheel bore and centering disk, gravity causes the wheel to drop while being centered. If the wheel is mounted the exact same way on the vehicle, then the wheel rotates reasonably well down the road at speed. However, if the wheel is mounted differently, which it commonly is, then the wheel rotates in an ovular path. The worst-case scenario is the wheel mounted with the valve stem positioned along the bottom, which results in the play being doubled and the vehicle wildly shaking when driven at speed, especially when reaching 70 Miles per Hour (MPH). These unwanted harmonics have resulted in truck owners adding various compounds inside the tire instead of balancing. These compounds dampen the vibration caused by the imbalance, but the compounds do not balance the wheel.

Moreover, as medium trucks have become more popular over the years using light truck tires, often referred to as LLKW or Light Commercial and Motorhome (LCM) wheels, the old wheel balancing heavy commercial system was shrunk to fit these wheels which usually weigh around 80 to 150 lbs. Many of these wheels are found on Class 3 to Class 5 trucks but also on small pickup trucks, SUVs, and passenger cars. There is a large aftermarket industry for selling huge and heavy wheels to passenger cars or pickup trucks. In other words, the overall weight of the wheel is a bigger issue than which vehicles the wheel can fit in. For LCM wheel balancing, a centering plate is used with holes to connect the studs to. The centering plate has the same bolt pattern as the wheel. Further, the spacer disk has an area for the stud nipple to rest on, that has the exact wheel dimension (bolt pattern) minus the diameter of the stud nipple, usually milled to max tolerance of 0.020 millimeters (mm) on the diameter. For example, a Ford F450 wheel has a bolt pattern Pitch Circle Diameter (PCD) of 10×225 mm. That means ten lug holes located and evenly divided on a 225 mm diameter. Five rim holes are drilled in the centering plate to usually ten-micron of accuracy between the stud and the hole in the centering plate. The spacer disk is milled to a diameter of 211 mm (225 mm minus the 14 mm diameter of the stud nipple). On heavy commercial trucks (e.g., 18-wheelers) the stud nipple is usually 17 mm. Furthermore, a small gain can usually be achieved by using a spring-loaded stud due to the variance in the wheel material thickness. The centering plate and the spacer disk work for all the various bolt patterns and center hole diameters as needed. Just like the issue with heavy commercial wheels, the play between the center bore of the wheel and the centering disk is relatively large providing less than perfect balancing results. The vehicles in question are often more sensitive to vibration than heavy commercial vehicles, so the problem has been growing.

An alternate solution has been used for light commercial and motorhome wheels up to about 150 lbs. in weight for a few years. The alternate solution involves a spacer disk and a collet with a usually low angle. The collet is forced into the center bore of the wheel by the spring located inside the hub of the balancer (most balancers now have captured springs, meaning that the spring is covered by a plastic or steel plate). Because the collet needs the spring to work, a spacer disk that is located and centered on the precision balancer shaft cannot possibly be used. Instead, the spacer disk is located on the outer diameter of the wheel balancer hub's faceplate. The problem with that solution is that the hub does not have the required accuracy to use studs with a nipple. The play between the wheel balancer hub and the inner diameter of the spacer disk is simply far too high. Hundreds of thousands of wheel balancers are used every day around the world, few of which have an accurate hub outer diameter. As a result, the spacer disk serves mainly to make room for the collet. Even though a centering plate with studs is used in combination, virtually all the centering is now done by the collet. This alternate solution is cheaper to manufacture compared to the above systems with many centering disks and a little easier for the operator to use; however, this solution is generally less accurate. In fact, on many wheels, this alternate solution is usually less accurate.

Therefore, the objective of the present invention is to provide a system that correctly balances LCM and heavy commercial vehicle wheels. The present invention provides a system that allows the spacer disk to be in contact with the wheel balancer hub spring, either directly or indirectly. This allows the use of a cone and/or collet to help center the wheel on the wheel balancer shaft. Another objective of the present invention is to facilitate the use of a centering plate and studs with extended nipples with the cone and/or collet to further assist the optimal centering of the wheel. The system of the present invention allows the studs to be positioned around the cone and/or collet so that each stud can lean back on the spacer disk for optimal centering. Additional features and benefits of the present invention are further discussed in the sections below.

### SUMMARY OF THE INVENTION

The present invention discloses a universal mounting system for a wheel balancer. The system of the present invention takes advantage of a balancer spring for optimal centering of the wheel being balanced. The system of the present invention is compatible with virtually all wheel balancer brands and models. To do so, the system of the present invention facilitates the direct interfacing of a spacer disk with the spring built into the wheel balancer hub. This allows the present invention to take full advantage of the fairly linear and correct spring pressure. Since the spacer disk is still centered on the precision balancer shaft, the system also allows the use of a centering plate and the corresponding studs with extended nipples. The system of the present invention further enables the use of low-tapered cones and/or collets that help center the wheel on the wheel balancer shaft. The low-tapered cones/collets enable the engagement of the stud nipples with the spacer disk. The balancing results are simply superior on medium wheels in the 80 pounds (lbs.) to 150 lbs. range (and may also work on the 300+ lbs. heavy commercial wheels).

### BRIEF DESCRIPTION OF THE DRAWINGS

FIG. 1 is a top-front-left perspective view of the spacer disk of the present invention.

FIG. 2 is a bottom-rear-right perspective view of the spacer disk of the present invention.

FIG. 3 is a front view of the spacer disk of the present invention.

FIG. 4 is a rear view of the spacer disk of the present invention.

FIG. 5 is a left view of the spacer disk of the present invention.

FIG. 6 is a vertical cross-sectional view of the spacer disk of the present invention taken along line 6-6 shown in FIG. 3.

FIG. 7 is a top-front-left perspective view of the centering collet of the present invention.

FIG. 8 is a bottom-rear-right perspective view of the centering collet of the present invention.

FIG. 9 is a top-front-left perspective view of the system of the present invention, wherein the spacer disk and the centering collet are shown mounted onto the wheel balancer hub and shaft, and wherein the system is shown with a centering plate and spring-loaded nuts.

FIG. 10 is a front view of the system of the present invention thereof.

FIG. 11 is a vertical cross-sectional view of the system of the present invention taken along line 11-11 shown in FIG. 10.

FIG. 12 is a top-front-left exploded perspective view of the system of the present invention thereof.

### DETAILED DESCRIPTION OF THE INVENTION

All illustrations of the drawings are for the purpose of describing selected versions of the present invention and are not intended to limit the scope of the present invention.

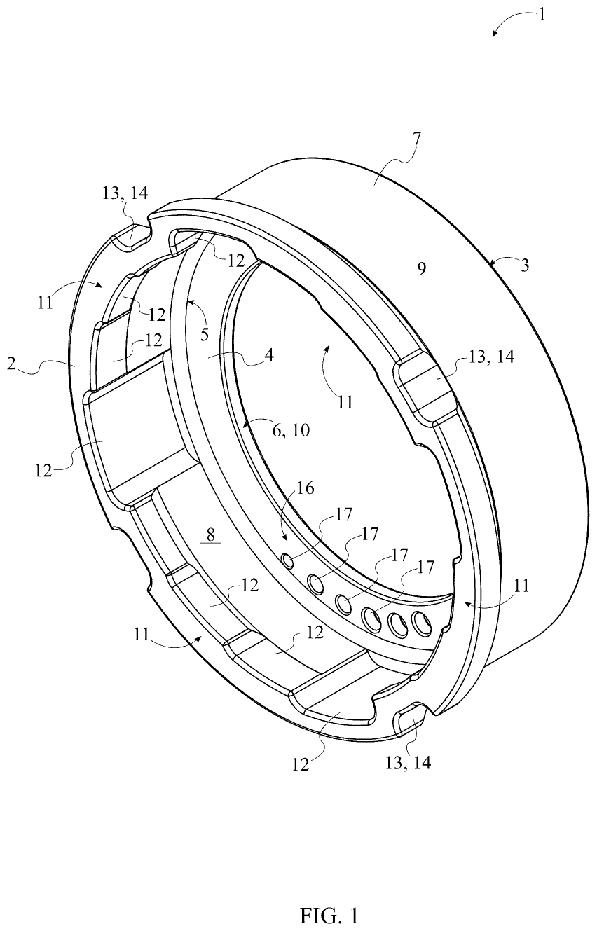

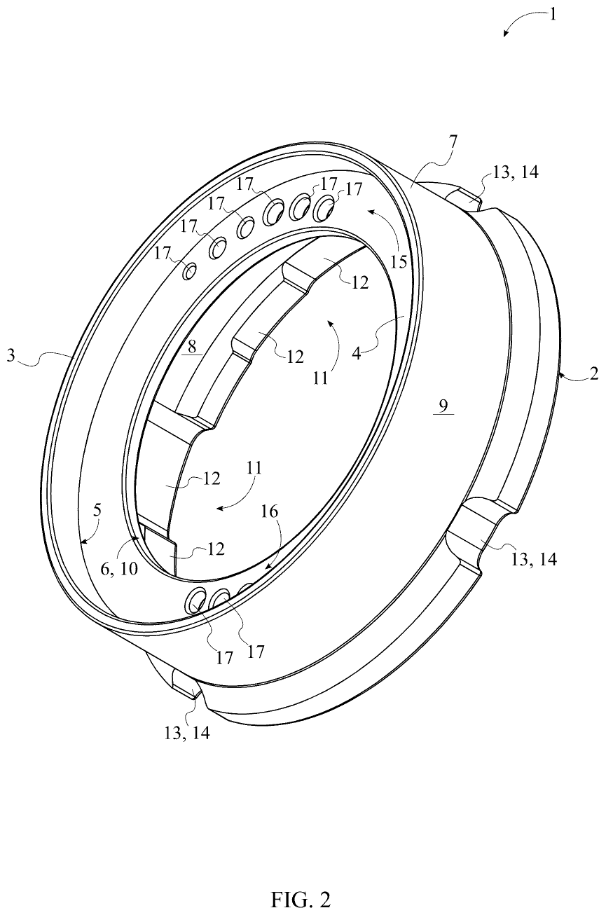

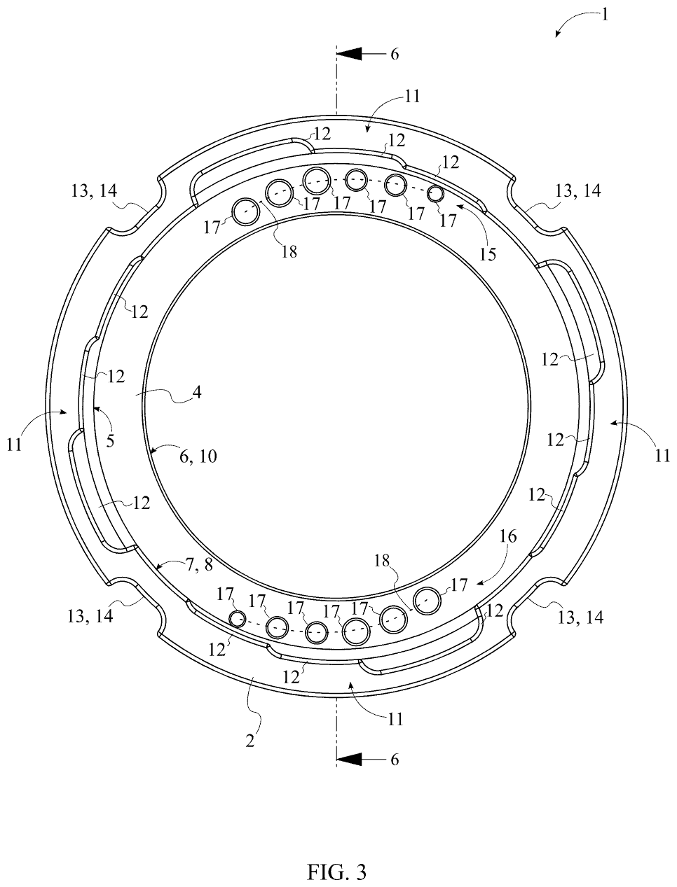

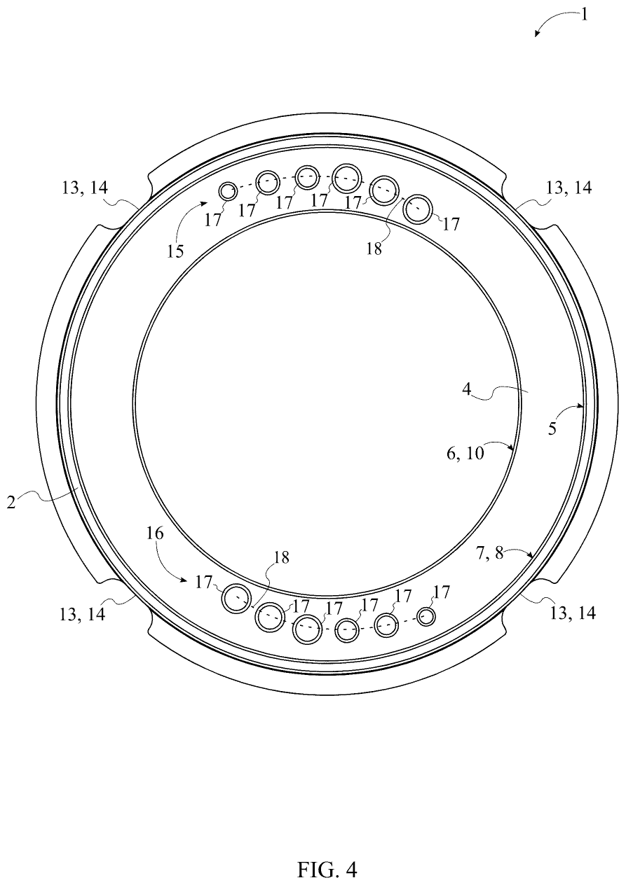

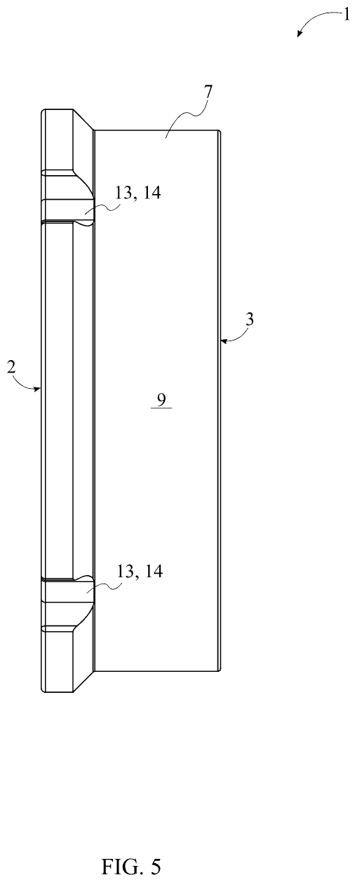

The present invention discloses a universal mounting system for a wheel balancer. The system of the present invention facilitates the mounting of a wheel to a wheel balancer in such a way that gravity effects are eliminated by utilizing the captured spring in the wheel balancer hub. As can be seen in FIGS. 1 through 6, the present invention preferably comprises a spacer disk 1. The spacer disk 1 is designed to center on a wheel balancer hub instead of the wheel balancer shaft for greater balancing accuracy. The spacer disk 1 is also designed to accommodate a low-tapered cone or collet as well as the necessary stud nipples to secure and center the selected wheel to the wheel balancer shaft. The spacer disk 1 gives the cone or collect direct access to the spring cover of the wheel balancer for proper balancing of the mounted wheel.

The general configuration of the aforementioned components enables the optimal balancing of a selected wheel using an existing wheel balancer. The spacer disk 1 is designed to be used with different existing wheel balancers and can accommodate wheels of different sizes. In general, the spacer disk 1 is forged, through-hardened, and then machined in hardened condition to obtain the best surface finish and tightest tolerances. The spacer disk 1 is then surface hardened to make the spacer disk 1 even more dent resistant and rustproof. This ensures optimal balancing results and a very long lifespan, during which balancing accuracy is always maintained. As can be seen in FIGS. 1 through 6, the spacer disk 1 comprises a first open base 2, a second open base 3, an annular ledge 4, a lateral disk wall 7, and a shaft-receiving hole 10. The first open base 2 corresponds to the portion of the spacer disk 1 that accommodates the cone or collet as well as the stud nipples used with a centering plate 26. The second open base 3 corresponds to the portion that accommodates the wheel balancer hub. The annular ledge 4 corresponds to the annular portion that allows the spacer disk 1 to be secured to the wheel balancer hub. The lateral disk wall 7 corresponds to the lateral portion of the spacer disk 1 between the first open base 2 and the second open base 3. The shaft-receiving hole 10 enables the wheel balancer shaft to be positioned through the spacer disk 1. Further, the annular ledge 4 is a ring-shaped flat body that comprises an outer annular rim 5 and an inner annular rim 6 corresponding to the outer edge and inner edge of the annular ledge 4, respectively.

In the preferred embodiment, the present invention can be arranged as follows: the first open base 2 and the second open base 3 are positioned opposite to each other about the lateral disk wall 7 due to the short cylindrical shape of the spacer disk 1, as can be seen in FIGS. 1 through 6. The overall size of the spacer disk 1 is determined based on the wheel balancer as well as the range of wheel sizes that the system of the present invention can be used with. The annular ledge 4 is positioned offset from the first open base 2 to form a recessed space adjacent to the first open base 2 that accommodates other balancing components such as the cone, the collet, the centering plate 26, etc. The annular ledge 4 is also positioned offset from the second open base 3 to form a recessed space adjacent to the second open base 3 that accommodates a portion of the wheel balancer hub.

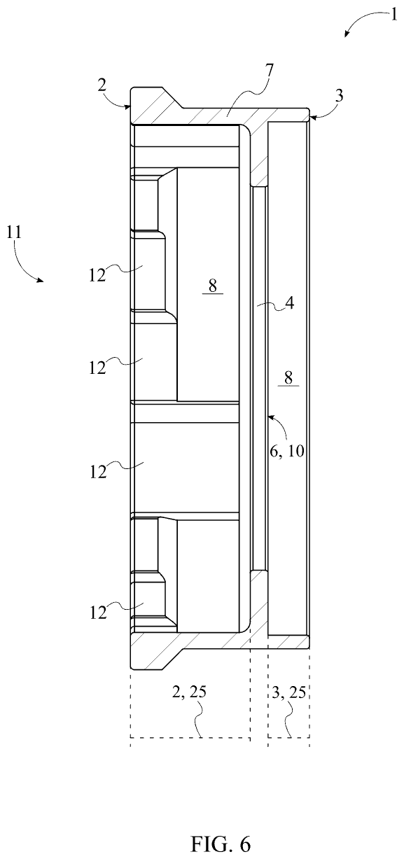

In the preferred embodiment, a ratio between a depth 25 from the first open base 2 to the annular ledge 4 and a depth 25 from the second open base 3 to the annular ledge 4 is 2.9, as can be seen in FIG. 6. This results in a larger recession being formed adjacent to the first open base 2 and a smaller recession being formed adjacent to the second open base 3. However, this ratio can change to match special designs of the wheel balancer and tire wheels. Further, the outer annular rim 5 is connected around the lateral disk wall 7 which results in the outer annular rim 5 having a diameter matching the inner diameter of the lateral disk wall 7, as can be seen in FIGS. 1 through 6. The inner annular rim 6 is also positioned concentric with the outer annular rim 5 to match the wheel balancer shaft being centered on the wheel balancer hub. Furthermore, the shaft-receiving hole 10 is delineated by the inner annular rim 6, which results in the shaft-receiving hole 10 matching the diameter of the inner annular rim 6. The shaft-receiving hole 10 has a diameter larger than the wheel balancer shaft with a size large enough to allow other balancing components such as the cover or collect to directly engage the spring cover on the wheel balancing hub.

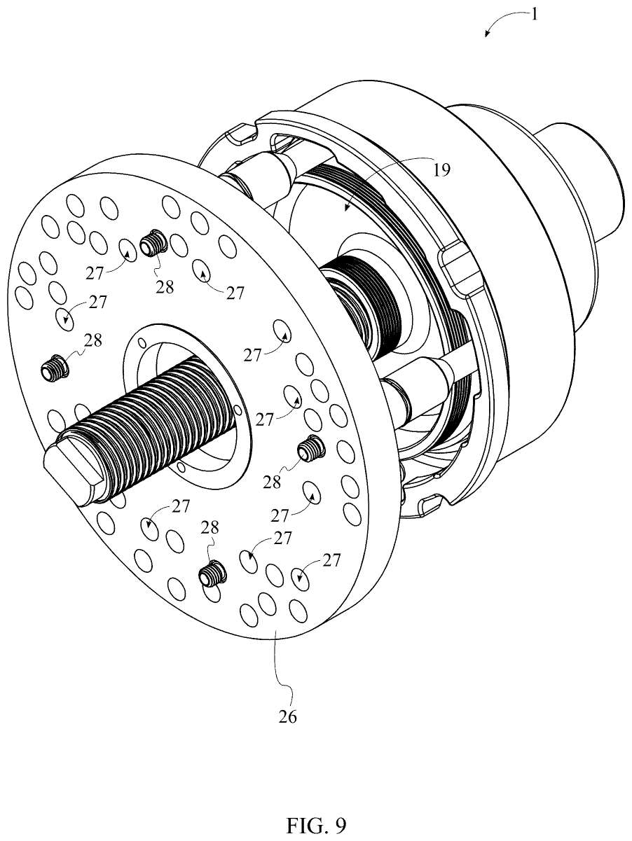

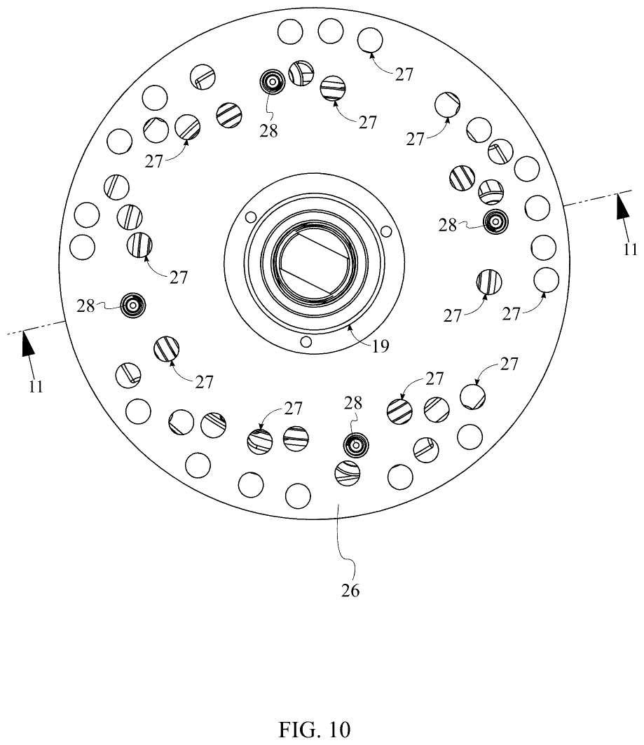

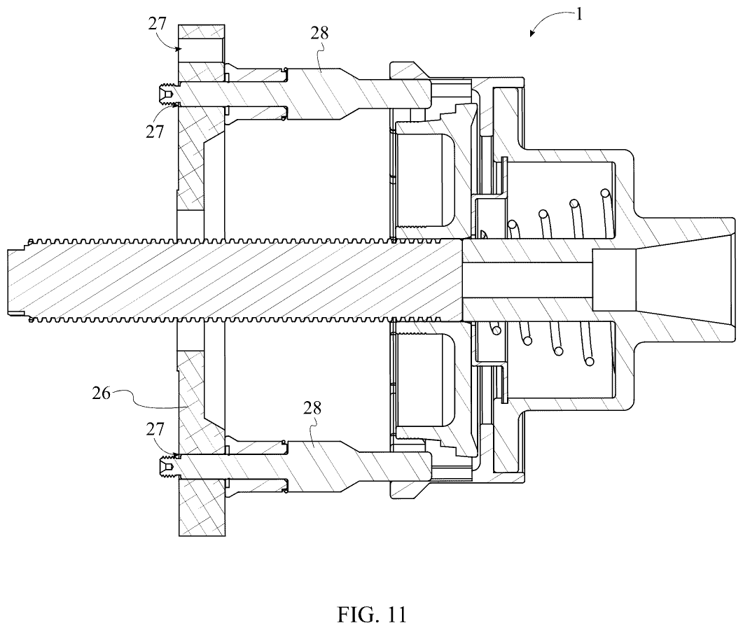

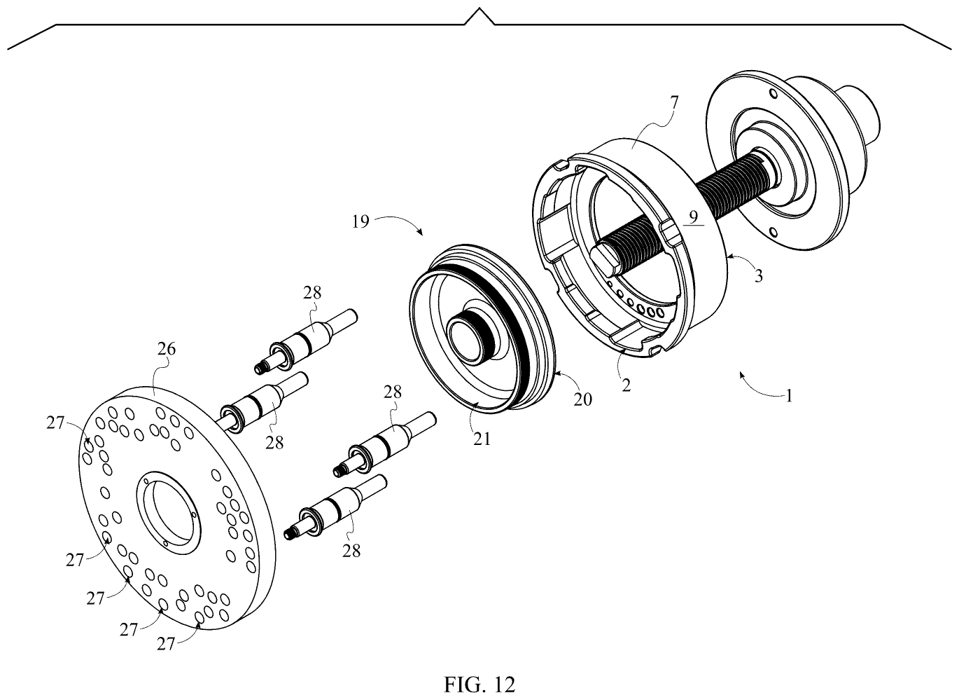

Allowing direct engagement of the cone or collet to the spring cover facilitates the optimal balancing of the selected wheel using an existing wheel balancer. As the selected wheel is clamped on the wheel balancer shaft using the centering plate 26 and the corresponding plurality of spring-loaded studs 28 with extended nipples, the captured spring in the wheel balancer hub pushes the cone or collet being used into the wheel bore of the selected wheel, as can be seen in FIGS. 9 through 12. The stud nipples lean on the spacer disk 1, thereby assisting the cone or collet with proper and perfect centering of the selected wheel on the wheel balancer. The spacer disk 1 is manufactured in such a way that the support area within the spacer disk 1 is much larger and easy to guide the stud nipples onto. In other embodiments, the spacer disk 1 can be modified to accommodate other balancing components or wheel balancer features.

To secure the spacer disk 1 to the wheel balancer hub, the spacer disk 1 may further comprise a plurality of first hub-attachment mechanisms 15 and a plurality of second hub-attachment mechanisms 16, as can be seen in FIGS. 1 through 6. The plurality of first hub-attachment mechanisms 15 and the plurality of second hub-attachment mechanisms 16 enable the fastening of the spacer disk 1 to the wheel balancer hub so that the spacer disk 1 rotates along with the wheel balancer hub. Fastening the spacer disk 1 to the wheel balancer hub is considered best practice when balancing heavy wheels using leaning studs. In addition, the plurality of first hub-attachment mechanisms 15 and the plurality of second hub-attachment mechanisms 16 enables the plurality of spring-loaded studs 28 on the centering plate 26 engaged through the lug holes of the selected wheel to lean on the spacer disk 1, thereby removing the effects of gravity, improving static centering, and greatly enhancing the balancing results of light duty pickup truck and motorhome wheels.

As can be seen in FIGS. 1 through 6, the plurality of first hub-attachment mechanisms 15 and the plurality of second hub-attachment mechanisms 16 each comprises a plurality of fastening holes 17 that accommodates the appropriate fasteners that can be used to torsionally connect the spacer disk 1 to the wheel balancer hub. The plurality of fastening holes 17 preferably includes several fastening holes of different sizes to accommodate different wheel balancer hubs that may utilize fasteners of various sizes. The plurality of first hub-attachment mechanisms 15 and the plurality of second hub-attachment mechanisms 16 are peripherally positioned on the annular ledge 4 to match the radial distribution of the corresponding fastener holes on the wheel balancer hub. Further, the plurality of first hub-attachment mechanisms 15 and the plurality of second hub-attachment mechanisms 16 are diametrically opposed to each other about the annular ledge 4. This way, the fastening holes of matching sizes are positioned opposite to each other to match the positioning of corresponding fastener holes on the wheel balancer hub.

Further, the plurality of fastening holes 17 is configured with a series of incremental hole sizes which are arranged in an arc configuration 18, as can be seen in FIGS. 1 through 6. The incremental sizes of the fastening holes accommodates fasteners of different sizes, and the arc configuration 18 allows the different-sized fastening holes to match the hole positions on wheel balancer hubs of different sizes. The arc configuration 18 is also concentrically positioned to the shaft-receiving hole 10 to better match the hole positions on wheel balancer hubs of different sizes. For example, the largest fastening holes can be positioned closer to the shaft-receiving hole 10, decreasingly smaller fastening holes are positioned further from the shaft-receiving hole 10, and the smallest fastening holes are positioned adjacent to the lateral disk wall 7. Furthermore, each of the plurality of fastening holes 17 traverses through the annular ledge 4 to form the corresponding holes on the annular ledge 4. In other embodiments, different fastening mechanisms can be implemented to torsionally secure the spacer disk 1 to the wheel balancer hub.

As previously discussed, the stud nipples of the corresponding stud being used with the centering plate 26 engage with the spacer disk 1 in such a way that the stud nipples rest on the spacer disk 1 to help center the selected wheel on the wheel balancer shaft, as can be seen in FIGS. 9 through 12. So, the spacer disk 1 may further comprise a plurality of smaller-stud-engagement features 11. The plurality of smaller-stud-engagement features 11 correspond to stud-engagement features that accommodate smaller wheel sizes. Moreover, the lateral disk wall 7 comprises an inner wall surface 8 corresponding to the internal cylindrical surface of the lateral disk wall 7. Each of the plurality of smaller-stud-engagement features 11 also comprises a plurality of stud-receiving slots 12 corresponding to several radial slots with a shape and size that accommodate the stud nipples engaging the spacer disk 1. The plurality of stud-receiving slots 12 is designed to laterally engage the corresponding stud nipple.

As can be seen in FIGS. 1 through 6, to implement the plurality of smaller-stud-engagement features 11, the plurality of smaller-stud-engagement features 11 is integrated into the inner wall surface 8 to form the smaller-stud-engagement features within the lateral disk wall 7. For example, the inner wall surface 8 can be milled to form the radial spaces corresponding to the plurality of stud-receiving slots 12 that receive the stud nipples. In addition, the plurality of smaller-stud-engagement features 11 is radially distributed about the lateral disk wall 7 to match the radial distribution of the plurality of spring-loaded studs 28 on the centering plate 26. For example, if five spring-loaded studs are used, the plurality of smaller-stud-engagement features 11 includes five smaller-stud-engagement features to engage the five spring-loaded studs. Furthermore, the plurality of stud-receiving slots 12 is configured with a series of incremental lateral depths to accommodate several smaller wheel sizes.

The series of incremental depths for the plurality of stud-receiving slots 12 can be implemented as follows: the plurality of smaller-stud-engagement features 11 may include three stud-receiving slots, as can be seen in FIGS. 1 through 6. Each of the three stud-receiving slots has a different Pitch Circle Diameter (PCD). The stud-receiving slot with the smallest PCD is the first slot in the series that is closer to the shaft-receiving hole 10. The stud-receiving slot with the intermediate PCD is positioned next in the series, and the stud-receiving slot with the largest PCD is the last slot in the series that is further away from the shaft-receiving hole 10. The configuration of the plurality of stud-receiving slots 12 allows the easy engagement the stud nipples with the appropriate stud-receiving slots. For example, as the plurality of spring-loaded studs 28 is inserted into the spacer disk 1 through the first open base 2, the stud nipples first engage the stud-receiving slots with the largest PCD. If the PCD of the plurality of spring-loaded studs 28 is smaller than the PCD of the stud-receiving slots with the largest PCD, the user can rotate the selected wheel so that stud nipples engage the stud-receiving slots with the intermediate PCD. Again, if the PCD of the plurality of spring-loaded studs 28 is smaller than the PCD of the stud-receiving slots with the intermediate PCD, the user can rotate the selected wheel again so that stud nipples engage the stud-receiving slots with the smallest PCD. Thus, the user does not have to guess when engaging the plurality of spring-loaded studs 28 with the spacer disk 1. In other embodiments, each of the plurality of smaller-stud-engagement features 11 may include additional stud-receiving slots with smaller PCDs to accommodate smaller wheel sizes.

In addition to accommodating smaller wheel sizes, the spacer disk 1 can also accommodate larger wheel sizes. As can be seen in FIGS. 1 through 6, the spacer disk 1 may further comprise a plurality of larger-stud-engagement features 13. The plurality of larger-stud-engagement features 13 accommodate the plurality of spring-loaded studs 28 on the centering plate 26 arranged to match larger wheels. Moreover, the lateral disk wall 7 further comprises an outer wall surface 9 corresponding to the external cylindrical surface of the lateral disk wall 7. To implement the plurality of larger-stud-engagement features 13, the plurality of larger-stud-engagement features 13 is integrated into the outer wall surface 9 due to the PCD of the larger-stud-engagement features being larger than the largest PCD of the smaller-stud-engagement feature. In addition, the plurality of larger-stud-engagement features 13 is radially distributed about the lateral disk wall 7 to match the radial distribution of the plurality of spring-loaded studs 28 on the centering plate 26.

Similar to the plurality of smaller-stud-engagement features 11, each of the plurality of larger-stud-engagement features 13 can include at least one stud-receiving slot 14, as can be seen in FIGS. 1 through 6. The at least one stud-receiving slot 14 is designed to accommodate the corresponding stud nipple that is passed through one of the lug holes on the selected wheel. In the preferred embodiment, the at least one stud-receiving slot 14 of each of the plurality of larger-stud-engagement features 13 has the same PCD which accommodates a single larger wheel size. However, in other embodiments, each of the plurality of larger-stud-engagement features 13 can include several stud-receiving slots like the plurality of stud-receiving slots 12. The several stud-receiving slots of the plurality of larger-stud-engagement features 13 can also be configured with a series of incremental lateral depths, each with a smaller PCD to accommodate larger wheels of different sizes.

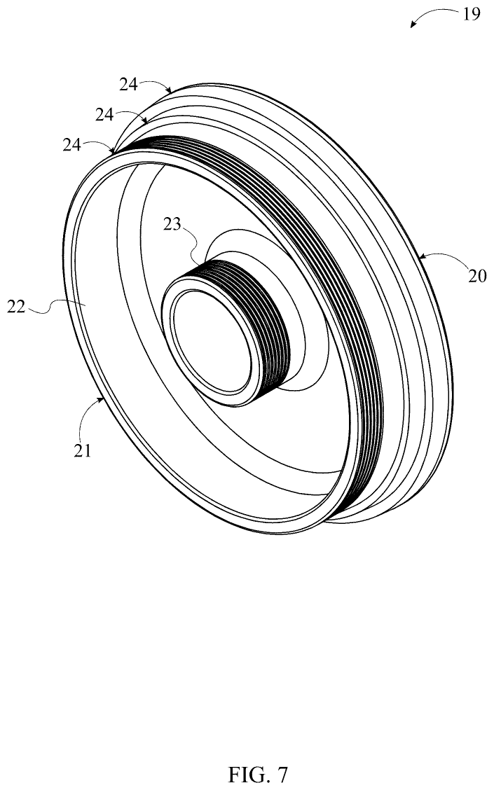

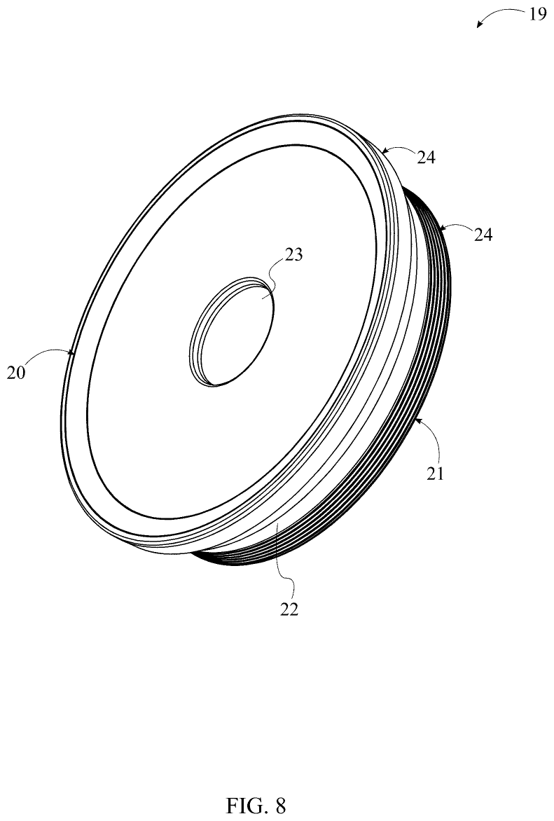

As previously discussed, the system of the present invention can accommodate existing low-tapered cones or collets to help center the selected wheel on the wheel balancer shaft. However, the system may also include custom cones or collets specially designed to work along with the spacer disk 1. As can be seen in FIGS. 7 and 8, the present invention may further comprise at least one centering collet 19. The at least one centering collet 19 is designed to engage the wheel bore of the selected wheel to help center the selected wheel on the wheel balancer shaft. The at least one centering collet 19 is made to the highest possible accuracy and with the smoothest surface finish. The low taper requires a super fine surface finish in order to avoid sticking inside the wheel bore. Further, the at least one centering collet 19 is plated and extremely rust-resistant even in very humid environments. The at least one centering collet 19 is relatively lightweight and features a built-in handle, making the at least one centering collet 19 easy to grip, install, and remove from the balancing machine.

In general, the at least one centering collet 19 comprises a closed collet base 20, an open collet base 21, a lateral collet wall 22, and a shaft-receiving sleeve 23, as can be seen in FIGS. 7 and 8. The closed collet base 20 corresponds to the portion of the at least one centering collet 19 that engages the spring cover on the wheel balancer hub. The open collet base 21 provides access to the shaft-receiving sleeve 23 within the at least one centering collet 19. The lateral collet wall 22 corresponds to lateral structure of the at least one centering collet 19 that engages the wheel bore. Further, the shaft-receiving sleeve 23 facilitates the mounting of the at least one centering collet 19 to the wheel balancer shaft. The shaft-receiving sleeve 23 provides a large cylindrical surface that prevents the external threading on the wheel balancer shaft from stopping the movement of the at least one centering collet 19 along the length of the wheel balancer shaft. The shaft-receiving sleeve 23 also serves as the built-in handle to enable the user to maneuver the at least one centering collet 19.

In the preferred embodiment, the at least one centering collet 19 can be arranged as follows: the closed collet base 20 and the open collet base 21 are positioned opposite to each other about the lateral collet wall 22 due to the overall short cylindrical structure of the at least one centering collet 19, as can be seen in FIGS. 7 and 8. The shaft-receiving sleeve 23 is also positioned in between the closed collet base 20 and the open collet base 21 to form a single solid structure. Further, the shaft-receiving sleeve 23 is centrally connected through the closed collet base 20 to secure the shaft-receiving sleeve 23 within the lateral collet wall 22. In addition, the shaft-receiving sleeve 23 and the lateral collet wall 22 are concentrically positioned with the shaft-receiving hole 10 to axially align the shaft-receiving sleeve 23 and the lateral collet wall 22 to the wheel balancer shaft. Furthermore, when the at least one centering collet 19 is mounted into the spacer disk 1, the closed collet base 20 is positioned within the lateral disk wall 7. This allows the closed collet base 20 to engage the spring cover on the wheel balancer hub to improve the wheel balancing. The closed collet base 20 is also positioned offset to the annular ledge 4 to allow the free engagement of the at least one centering collet 19 to the spring cover.

Like the spacer disk 1, the at least one centering collet 19 is designed to accommodate wheels of different sizes. As can be seen in FIGS. 7 and 8, the at least one centering collet 19 may further comprise a plurality of bore-engagement features 24 that enables the at least one centering collet 19 to engage the wheel bore of wheels of different sizes. In the preferred embodiment, the closed collet base 20 is diametrically larger than the open collet base 21 due to the low-tapered design of the at least one centering collet 19. In addition, the plurality of bore-engagement features 24 is laterally integrated around the lateral collet wall 22 to form outer rings of different diameters that match wheel bores of different sizes. The plurality of bore-engagement features 24 is also configured as a plurality of step-up features from the open collet base 21 to the closed collet base 20. This way, when the at least one centering collet 19 is engaged into the wheel bore of the selected wheel, the wheel bore first engages the bore-engagement feature adjacent to the open collet base 21, which is the smallest bore-engagement feature. As the stud nipples of the plurality of spring-loaded studs 28 on the centering plate 26 engage the spacer disk 1 through the lug holes of the selected wheel, the wheel bore moves up the bore-engagement features until the wheel bore engages the bore-engagement feature of matching size. Further, as the captured spring in the wheel balancer hub pushes the closed collet base 20 back, the at least one centering collet 19 is forced into the wheel bore of the selected wheel. Thus, the at least one centering collet 19 further facilitates the mounting and improves the centering of the selected wheel on the wheel balancer shaft.

In some embodiments, the bore-engagement feature adjacent to the open collet base 21 corresponds to an oversized “rest-stop” that enables heavy wheels to rest securely on the at least one centering collet 19 without the risk of dropping onto the wheel balancer shaft, as can be seen in FIGS. 7 and 8. This protects the wheel bore and the threading on the wheel balancer shaft. In addition, large extended lips can be incorporated around the open collet base 21 and the closed collet base 20 to ensure that the at least one centering collet 19 can be dropped without the crucial low-taper step-up features colliding with the concrete floor. The crucial low-taper step-up features are machined to a surface finish better than an Average Surface Roughness (Ra) of Ra24, ensuring that the selected wheel can easily slide up on the step-up features for optimal centering and balancing results. In other embodiments, different collet designs may be implemented to accommodate special wheel designs.

As previously discussed, the system of the present invention may further include a centering plate 26 and a plurality of spring-loaded studs 28 that help with the balancing of the selected wheel, as can be seen in FIGS. 9 through 12. The centering plate 26 is a lightweight plate with a plurality of stud holes 27 distributed radially along the centering plate 26. For example, the centering plate 26 can be an Aluminum plate that is hard anodized for durability. Each stud hole is clearly marked and color-coded to facilitate fast insertion of the plurality of spring-loaded studs 28. The color coding also ensures that each of the plurality of spring-loaded studs 28 is placed into the correct stud hole on the first attempt, saving time and avoiding frustration. The plurality of stud holes 27 is distributed along the centering plate 26 to cover several bolt patterns of different wheel sizes. Further, the plurality of spring-loaded studs 28 includes several spring-loaded studs that are also through-hardened, machined in hard condition, and then further surface-hardened for durability in case of impact with a concrete floor.

Each of the plurality of spring-loaded studs 28 also preferably includes an enlarged base that enhances the durability of the centering plate 26, providing additional protection in case of a drop on the floor, as can be seen in FIGS. 9 through 12. Further, some spring-loaded studs of the plurality of spring-loaded studs 28 includes an OSB feature that facilitates the engagement of the spring-loaded stud into the corresponding stud hole on the centering plate 26. Furthermore, a wing nut and a bushing can be used to fully fasten the system to the wheel balancer hub to safely proceed with the balancing process using the wheel balancer. In other embodiments, different clamping tools can be utilized to secure the selected wheel to the spacer disk 1.

Although the invention has been explained in relation to its preferred embodiment, it is to be understood that many other possible modifications and variations can be made without departing from the spirit and scope of the invention.

What is claimed is:

1. A universal mounting system for a wheel balancer comprising:
a spacer disk;
the spacer disk comprising a first open base, a second open base, an annular ledge, a lateral disk wall, and a shaft-receiving hole;
the annular ledge comprising an outer annular rim and an inner annular rim;
the first open base and the second open base being positioned opposite to each other about the lateral disk wall;
the annular ledge being positioned offset from the first open base;
the annular ledge being positioned offset from the second open base;
the outer annular rim being connected around the lateral disk wall;
the inner annular rim being positioned concentric with the outer annular rim; and
the shaft-receiving hole being delineated by the inner annular rim.

2. The universal mounting system for a wheel balancer as claimed in claim 1, wherein a ratio between a depth from the first open base to the annular ledge and a depth from the second open base to the annular ledge is 2.9.

3. The universal mounting system for a wheel balancer as claimed in claim 1 further comprising:
the spacer disk further comprising a plurality of first hub-attachment mechanisms and a plurality of second hub-attachment mechanisms;
the plurality of first hub-attachment mechanisms and the plurality of second hub-attachment mechanisms each comprising a plurality of fastening holes;
the plurality of first hub-attachment mechanisms and the plurality of second hub-attachment mechanisms being peripherally positioned on the annular ledge;
the plurality of first hub-attachment mechanisms and the plurality of second hub-attachment mechanisms being diametrically opposed to each other about the annular ledge;
the plurality of fastening holes being configured with a series of incremental hole sizes;
the plurality of fastening holes being arranged in an arc configuration;
the arc configuration being concentrically positioned to the shaft-receiving hole; and
each of the plurality of fastening holes traversing through the annular ledge.

4. The universal mounting system for a wheel balancer as claimed in claim 1 further comprising:
the spacer disk further comprising a plurality of smaller-stud-engagement features;
the lateral disk wall comprising an inner wall surface;
each of the plurality of smaller-stud-engagement features comprising a plurality of stud-receiving slots;
the plurality of smaller-stud-engagement features being integrated into the inner wall surface;
the plurality of smaller-stud-engagement features being radially distributed about the lateral disk wall; and
the plurality of stud-receiving slots being configured with a series of incremental lateral depths.

5. The universal mounting system for a wheel balancer as claimed in claim 1 further comprising:
the spacer disk further comprising a plurality of larger-stud-engagement features;
the lateral disk wall comprising an outer wall surface;
the plurality of larger-stud-engagement features being integrated into the outer wall surface; and
the plurality of larger-stud-engagement features being radially distributed about the lateral disk wall.

6. The universal mounting system for a wheel balancer as claimed in claim 5, wherein each of the plurality of larger-stud-engagement features includes at least one stud-receiving slot.

7. The universal mounting system for a wheel balancer as claimed in claim 1 further comprising:
at least one centering collet;
the at least one centering collet comprising a closed collet base, an open collet base, a lateral collet wall, and a shaft-receiving sleeve;
the closed collet base and the open collet base being positioned opposite to each other about the lateral collet wall;
the shaft-receiving sleeve being positioned in between the closed collet base and the open collet base;
the shaft-receiving sleeve being centrally connected through the closed collet base;
the shaft-receiving sleeve and the lateral collet wall being concentrically positioned with the shaft-receiving hole;
the closed collet base being positioned within the lateral disk wall; and
the closed collet base being positioned offset to the annular ledge.

8. The universal mounting system for a wheel balancer as claimed in claim 7 further comprising:
the at least one centering collet further comprising a plurality of bore-engagement features;
the closed collet base being diametrically larger than the open collet base;
the plurality of bore-engagement features being laterally integrated around the lateral collet wall; and
the plurality bore-engagement features being configured as a plurality of step-up features from the open collet base to the closed collet base.

9. A universal mounting system for a wheel balancer comprising:
a spacer disk;
at least one centering collet;
the spacer disk comprising a first open base, a second open base, an annular ledge, a lateral disk wall, and a shaft-receiving hole;
the annular ledge comprising an outer annular rim and an inner annular rim;
the at least one centering collet comprising a closed collet base, an open collet base, a lateral collet wall, and a shaft-receiving sleeve;
the first open base and the second open base being positioned opposite to each other about the lateral disk wall;
the annular ledge being positioned offset from the first open base;
the annular ledge being positioned offset from the second open base;
the outer annular rim being connected around the lateral disk wall;
the inner annular rim being positioned concentric with the outer annular rim;
the shaft-receiving hole being delineated by the inner annular rim;
the closed collet base and the open collet base being positioned opposite to each other about the lateral collet wall;
the shaft-receiving sleeve being positioned in between the closed collet base and the open collet base;
the shaft-receiving sleeve being centrally connected through the closed collet base;
the shaft-receiving sleeve and the lateral collet wall being concentrically positioned with the shaft-receiving hole;
the closed collet base being positioned within the lateral disk wall; and
the closed collet base being positioned offset to the annular ledge.

10. The universal mounting system for a wheel balancer as claimed in claim 9, wherein a ratio between a depth from the first open base to the annular ledge and a depth from the second open base to the annular ledge is 2.9.

11. The universal mounting system for a wheel balancer as claimed in claim 9 further comprising:
the spacer disk further comprising a plurality of first hub-attachment mechanisms and a plurality of second hub-attachment mechanisms;
the plurality of first hub-attachment mechanisms and the plurality of second hub-attachment mechanisms each comprising a plurality of fastening holes;
the plurality of first hub-attachment mechanisms and the plurality of second hub-attachment mechanisms being peripherally positioned on the annular ledge;
the plurality of first hub-attachment mechanisms and the plurality of second hub-attachment mechanisms being diametrically opposed to each other about the annular ledge;
the plurality of fastening holes being configured with a series of incremental hole sizes;
the plurality of fastening holes being arranged in an arc configuration;
the arc configuration being concentrically positioned to the shaft-receiving hole; and
each of the plurality of fastening holes traversing through the annular ledge.

12. The universal mounting system for a wheel balancer as claimed in claim 9 further comprising:
the spacer disk further comprising a plurality of smaller-stud-engagement features;
the lateral disk wall comprising an inner wall surface;
each of the plurality of smaller-stud-engagement features comprising a plurality of stud-receiving slots;
the plurality of smaller-stud-engagement features being integrated into the inner wall surface;
the plurality of smaller-stud-engagement features being radially distributed about the lateral disk wall; and
the plurality of stud-receiving slots being configured with a series of incremental lateral depths.

13. The universal mounting system for a wheel balancer as claimed in claim 9 further comprising:
the spacer disk further comprising a plurality of larger-stud-engagement features;
the lateral disk wall comprising an outer wall surface;
the plurality of larger-stud-engagement features being integrated into the outer wall surface; and
the plurality of larger-stud-engagement features being radially distributed about the lateral disk wall.

14. The universal mounting system for a wheel balancer as claimed in claim 13, wherein each of the plurality of larger-stud-engagement features includes at least one stud-receiving slot.

15. The universal mounting system for a wheel balancer as claimed in claim 9 further comprising:
the at least one centering collet further comprising a plurality of bore-engagement features;
the closed collet base being diametrically larger than the open collet base;
the plurality of bore-engagement features being laterally integrated around the lateral collet wall; and
the plurality bore-engagement features being configured as a plurality of step-up features from the open collet base to the closed collet base.
